(19) United States
(12) Patent Application Publication
(10) Pub. No.: US 2021/0039826 A1
(43) Pub. Date: Feb. 11, 2021

(54) METHODS AND DEVICES FOR INTEGRATING AND ADAPTING PRODUCTS WITH TETHERING SYSTEMS

(71) Applicant: Jennifer T. Naddy, Rome, GA (US)

(72) Inventor: Jennifer T. Naddy, Rome, GA (US)

(21) Appl. No.: 16/942,909

(22) Filed: Jul. 30, 2020

Related U.S. Application Data
(60) Provisional application No. 62/883,043, filed on Aug. 5, 2019.

(51) Int. Cl. B65D 1/40; B65D 1/02; B65D 55/16

(52) U.S. Cl. CPC B65D 1/40; B65D 55/16; B65D 1/02

(57) ABSTRACT

A tethering system is presented. The system has a first magnet positioned in a first cavity of a first item such that the first magnet is out of sight of a user. A second magnet is coupled to a second item. The second item is movable about and between a first position, in which the magnetic force between the first magnet and the second magnet is not strong enough to couple the second item to the first item, and a second position, in which the magnetic force between the first magnet and the second magnet is strong enough to releasably, securedly couple the second item to the first item.

### CROSS-REFERENCE TO RELATED APPLICATIONS

This application claims priority to and the benefit of U.S. Provisional Patent Application No. 62/883,043, entitled METHODS AND DESIGNS FOR INTEGRATING AND ADAPTING PRODUCTS WITH TETHERING SYSTEMS, filed on Aug. 5, 2019, which is incorporated herein in its entirety by reference.

### FIELD OF THE INVENTION

This invention relates generally to methods, devices and systems to tether a first item to a second item. More particularly, this invention relates to methods, devices and systems that assists a user to tether a first item to a second item to prevent the first item from being misplaced, damaged and the like.

### BACKGROUND OF THE INVENTION

The design of various current consumer products/devices created for consumer convenience (such as, for example, water bottles, travel mugs, thermoses, snack boxes, school boxes and the like) frequently do not take into consideration how to manage removeable components. Therefore, many of those removable and/or supplemental components can get lost, get damaged, and/or frustratingly fall out of reach, etc. These issues make products having removable components less consumer-friendly.

Pieces can go missing from expensive bottles and devices that without those pieces, make the bottle or device unusable in their intended use. For example, if a user lost the cap to an insulated bottle, liquid in the bottle would not be as hot or cold and the liquid would be more apt to spill. A driver of a car can become distracted if removeable pieces of a bottle or device falls while driving. What is needed is a device, system and method to tether removeable pieces to the primary product/device in such a way that would not have a negative effect on, and potentially improve, the normal function of the product/device without fear of losing an important removable piece.

### SUMMARY

Presented herein are a methods, devices and systems for integrating and adapting products with tethering. The tethering systems can provide a means for releasably, securedly and easily attaching a first item to a second item.

Generally, provided herein is a tethering system comprising a bottle defining an interior bottle chamber for holding a liquid, the bottle comprising an interior bottle wall and an outer bottle wall spaced from the interior bottle wall a predetermined distance to define a first cavity; a removable lid for sealing the interior bottle chamber; at least one first magnet coupled to and positioned in the first cavity of the bottle such that the first magnet is out of sight of a user of the system; and at least one second magnet coupled to the lid, wherein the lid is movable about and between a closed position, in which the interior bottle chamber is sealed by the lid, to an open position, in which the interior bottle chamber is not sealed by the lid and in which only a magnetic force between the first magnet and the second magnet securedly, releasably holds the lid in the open position.

Also provided herein is a method of tethering a first item to a second item, the method comprising providing a bottle defining an interior bottle chamber for holding a liquid, the bottle comprising an interior bottle wall and an outer bottle wall spaced from the interior bottle wall a predetermined distance to define a first cavity; providing a removable lid for sealing the interior bottle chamber; positioning the lid in a closed position in which the interior bottle chamber of the bottle is sealed by the lid; coupling at least one first magnet in the first cavity of the bottle such that the first magnet is out of sight of a user of the system; coupling at least one second magnet to the lid, and moving the lid from the closed position to an open position, in which the interior bottle chamber is not sealed by the lid and in which only a magnetic force between the first magnet and the second magnet securedly, releasably holds the lid in the open position.

Also provide is a tethering system comprising: a cooler defining an interior cooler chamber, the cooler comprising an interior cooler wall and an outer cooler wall spaced from the interior cooler wall a predetermined distance to define a first cavity; a bottle for holding a liquid; at least one first magnet coupled to and positioned in the first cavity of the cooler such that the first magnet is out of sight of a user of the system; and at least one second magnet coupled to the bottle, wherein the bottle is movable about and between a first position, in which the magnetic force between the first magnet and the second magnet is not strong enough to couple the bottle to the cooler, and a second position, in which the magnetic force between the first magnet and the second magnet is strong enough to securedly, releasably couple the bottle to the cooler.

Related methods of operation are also provided. Other apparatuses, methods, systems, features, and advantages of the tethering system and the method of its use will be or become apparent to one with skill in the art upon examination of the following figures and detailed description. It is intended that all such additional apparatuses, methods, systems, features, and advantages be included within this description, be within the scope of the tethering system and the method of its use, and be protected by the accompanying claims.

### DESCRIPTION OF THE FIGURES

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 is a cross-sectional view of a tethering system of the present application, according to one aspect, showing a second item coupled to a first item in a first position, wherein the first item comprises a first magnet.

FIG. 2 is a cross-sectional view of the tethering system of FIG. 1, wherein the first item comprises a plurality of first magnets.

FIG. 3 is a cross-sectional view of a tethering system of FIG. 1, showing the second item coupled to the first item in a second position.

FIG. 4 is a perspective view of a tethering system of the present application, according to another aspect, showing a first item comprising an embedded first magnet.

FIG. 5 is a perspective view of a tethering system of FIG. 4, showing a second item coupled to the first item in a second position.

FIG. 6 is a perspective view of a tethering system of the present application, according to another aspect, showing a first item and a second item in a first position.

FIG. 7 is a perspective view of a second item of the tethering system of the present application, according to another aspect.

FIG. 8 is a perspective view of a tethering system of the present application, according to another aspect, showing a first item comprising a cover.

### DESCRIPTION OF THE INVENTION

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “element” includes aspects having two or more such elements unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Terms used herein, such as “exemplary” or “exemplified,” are not meant to show preference, but rather to explain that the aspect discussed thereafter is merely one example of the aspect presented.

The term “substantially,” as used herein, may be applied to modify any quantitative representation that could permissibly vary without resulting in a change in the basic function to which it is related.

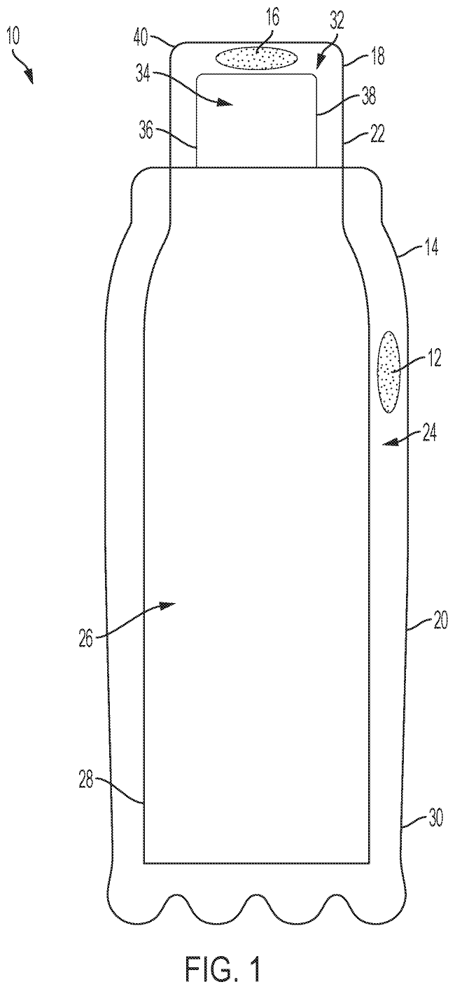

Presented herein is a tethering device, system and method of use for securedly, releasably attaching a first item to a second item. In one aspect and as illustrated in FIG. 1, the tethering system 10 comprises at least one first magnet 12 coupled to a first item 14, and at least one second magnet 16 coupled to a second item 18. As can be appreciated, each of the first magnet 12 and the second magnet 16 can be permanent magnets that can attach to ferromagnetic materials without the need of an electrical current. In an example, the first magnet 12 can be coupled to a bottle 20, and the second magnet 16 can be coupled to a cap or lid 22 of the bottle 20. In use, the lid 22 can be positioned adjacent the first magnet 12 of the bottle 20 such that a magnetic force between the first magnet 12 and the second magnet 16 secures the lid 22 to the bottle 20.

In one aspect, the first item 14 can define a first cavity 24 therein such that the first magnet 12 can be positioned in the first cavity 24. In this aspect, the first magnet 12 can then be out of sight of a user of the system 10. For example, if the first item 14 is the bottle 20, the bottle 20 can define an interior bottle chamber 26 for holding a liquid comprising an interior bottle wall 28. The bottle 20 can further comprise an outer bottle wall 30 spaced from the interior bottle wall 28 a predetermined distance to define the first cavity 24. The first magnet 12 can be positioned in this first cavity 24 in order to be hidden from the user while still creating enough magnetic force to attract the second magnet 16. Alternatively, the first magnet 12 can be positioned on a surface of the first item 14 that is normally out of sight, such as an underside of the bottle 20. The first magnet 12 can be securedly attached to the first item 14 with adhesives such as glue, tape and the like. Optionally, if the first item 14 is formed from a ferromagnetic material, the first magnet 12 can be securedly attached to the first item 14 with magnetic force. In another aspect, it is contemplated that the first magnet 12 can be embedded in a wall of the first item 14 or be coupled to the first item 14 such that the first magnet 12 is not hidden from the user. For example, the first magnet 12 can be securedly attached to or embedded in the inner bottle wall 28 and/or the outer bottle wall 30.

Similarly, in another aspect, the second item 18 can define a second cavity 32 therein such that the second magnet 16 can be positioned in the second cavity 32. In this aspect, the second magnet 16 can then be out of sight of a user of the system 10. For example, if the second item 18 is the lid 22, the lid 22 can define an interior lid chamber 34 for receiving a neck 36 of the bottle 20 comprising an interior lid wall 38. The lid 22 can further comprise an outer lid wall 40 spaced from the interior lid chamber 34 a predetermined distance to define the second cavity 32. The second magnet 16 can be positioned in this second cavity 32 in order to be hidden from the user while still creating enough magnetic force to attract the first magnet 12. Alternatively, the second magnet 16 can be positioned on a surface of the second item 18 that is normally out of sight, such as an underside of the lid 22. The second magnet 16 can be securedly attached in the second item 18 with adhesives such as glue, tape and the like. Optionally, if the second item 18 is formed from a ferromagnetic material, the second magnet 16 can be securedly attached to the second item 18 with magnetic force. In another aspect, it is contemplated that the second magnet 16 can be embedded in a wall of the second item 18 or be coupled to the second item 18 such that the second magnet 16 is not hidden from the user. For example, the second magnet 16 can be securedly attached to or embedded in the inner lid wall 38 and/or the outer lid wall 40.

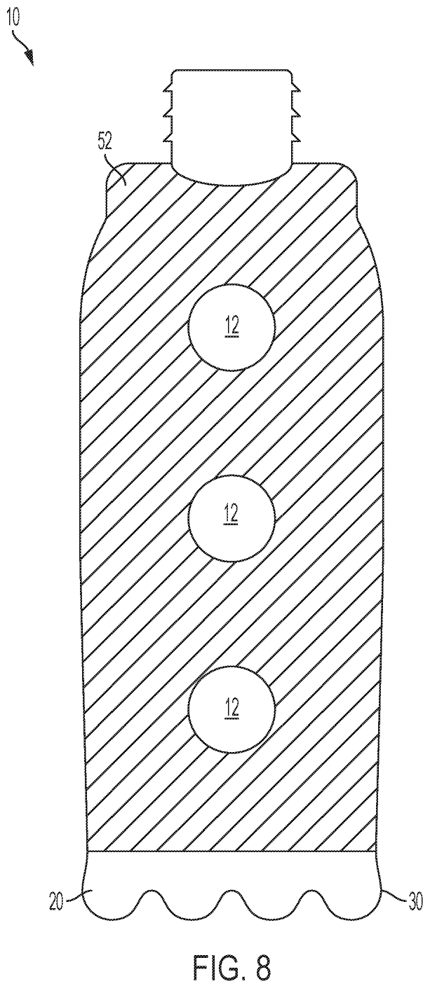

The first magnet 12 can be sized and shaped to fit in the first cavity 24 of the first item 14, while still creating enough magnetic force to attract the second magnet 16. For example, the first magnet 12 can have a thickness substantially equal to the thickness of the first cavity 24. Optionally, the first magnet 12 can have a thickness less than the thickness of the first cavity 24. In one aspect, the first magnet 12 can be sized and shaped to be embedded in a wall of the first item 14 without protruding from the wall of the first item 14 while still creating enough magnetic force to attract the second magnet 16. For example, the first magnet 12 can be sized and shaped to be embedded in the outer bottle wall 30 and/or the interior bottle wall 28. In another aspect, the first magnet 12 can be sized and shaped so that the first magnet 12 has sufficient strength to attract the second magnet 16 through additional materials. For example, and as illustrated in FIG. 8, if the bottle 20 has a silicone or neoprene cover 52 over at least a portion of the outer bottle wall 30, the first magnet 12 can be sized and shaped so that the first magnet 12 attracts the second magnet 16 through the cover 52. Optionally, the first magnet 12 can be at least partially embedded in the neoprene cover 52 so that the second item 18 can be coupled directly to the cover 52. That is, the first magnet 12 can have sufficient magnetic strength to attract the second magnet 16 through the cover 52, or the first magnet 12 can be positioned in the cover 52.

The second magnet 16 can be sized and shaped to fit in the second cavity 32 of the second item 18, while still creating enough magnetic force to attract the first magnet 12. For example, the second magnet 16 can have a thickness substantially equal to the thickness of the second cavity 32. Optionally, the second magnet 18 can have a thickness less than the thickness of the second cavity 32. In one aspect, the second magnet 16 can be sized and shaped to be embedded in a wall of the second item 18 without protruding from the wall of the second item 18 while still creating enough magnetic force to attract the first magnet 12. For example, the second magnet 16 can be sized and shaped to be embedded in the outer lid wall 40 and/or the inner lid wall 38. In another aspect, the second magnet 16 can be sized and shaped so that the second magnet 16 has sufficient strength to attract the first magnet 12 through additional materials.

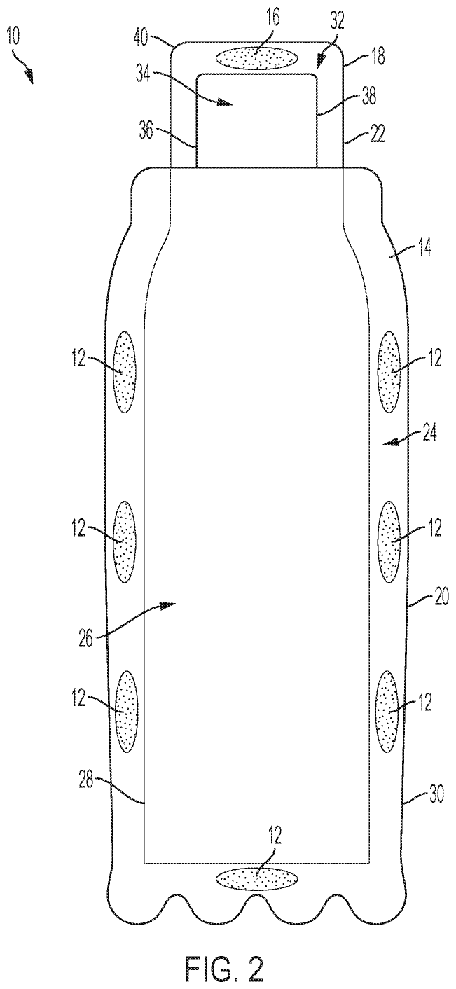

As illustrated in FIG. 2, the at least one first magnet 12 can comprise a plurality of first magnets 12. For example, the at least one first magnet 12 can comprise two, three, four, five, six, seven, eight, nine, ten or more than ten first magnets 12. In one aspect, the plurality of first magnets 12 can be spaced around the first item 14 from each other a predetermined distance. In this aspect, the second item 18 can be securedly, releasably attached to the first item 14 at any of the plurality of locations of the first magnet 12. Optionally, the plurality of first magnets 12 need not be spaced around the first item 14 and can be grouped in a desired area of the first item 14. In another aspect, if the at least one first magnet 12 comprise a plurality of first magnets 12, a plurality of items can be securedly, releasably attached to the first item 14. For example, the second item 18 can be coupled to one first magnet 12 and a third item (not shown) can be coupled to a different first magnet 12. In this manner, a number of items equal to the number of first magnets 12 can be coupled to the first item 14.

Similarly, in one aspect, the at least one second magnet 16 can comprise a plurality of second magnets 16. For example, the at least one second magnet 16 can comprise two, three, four, five, six, seven, eight, nine, ten or more than ten second magnets 16. The plurality of second magnets 16 can be spaced around the second item 18 from each other a predetermined distance. In this aspect, the first item 14 can be securedly, releasably attached to the second item 18 at any of the plurality of locations of the second magnet 16. Optionally, the plurality of second magnets 16 need not be spaced around the second item 18 and can be grouped in a desired area of the second item 18 so that it is easy for a user of the system 10 to overlie at least one of the hidden first magnets 12 with the second magnet 16.

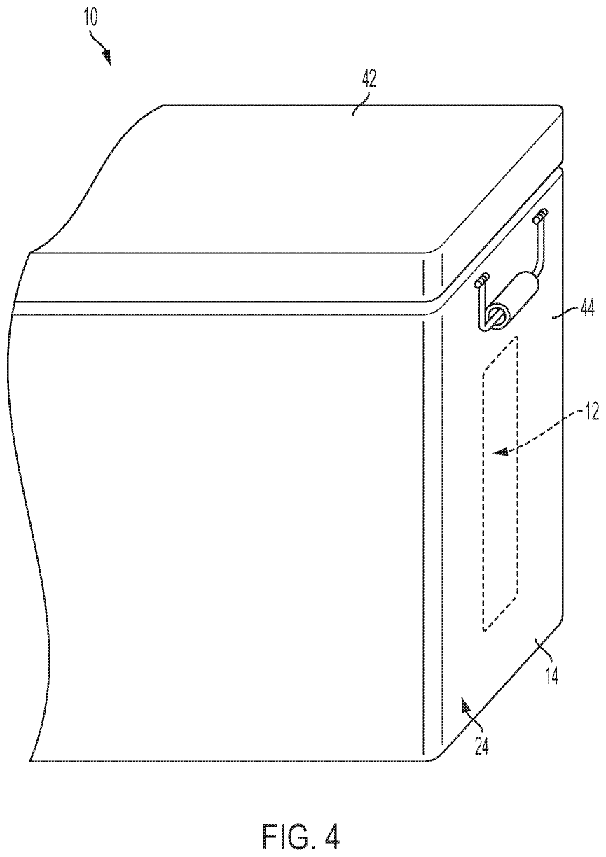

The first magnet 12 and the second magnet 16 can be substantially circular in shape. Optionally, the first magnet 12 and/or the second magnet 16 can have other shapes, such as substantially square, oval, rectangular or any other shape. For example, and as shown in FIG. 4, the first magnet 12 can be substantially linear. In this example, the length of the first magnet 12 can be selected so that the first magnet 12 extends for a desired portion of the first item 14 so that it is easy for a user to align the second magnet 16 with the first magnet 12. In other examples, the first magnet 12 and/or the second magnet 16 can have an area selected so that it is easy for a user to align the second magnet 16 with the first magnet 12.

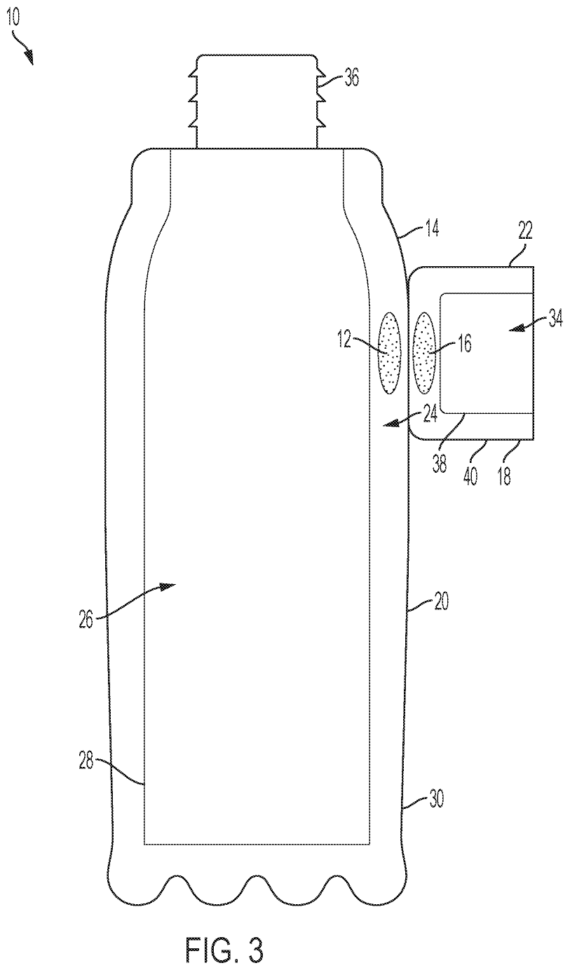

With reference to FIG. 3, the second item 18 can be securedly, releasably attaching to the first item 14 item by aligning at least a portion of the second magnet 16 with the first magnet 12. With the second magnet 16 at least partially aligned with and/or overlying at least a portion of the first magnet 12, a magnetic force between the first magnet 12 and the second magnet 16 can securedly, releasably couple the second item 18 to the first item 14. If the first magnet 12 comprises a plurality of first magnets 12, the second item 16 can be coupled to the first item 14 with any of the first magnets 12.

In use, the second item 18 can be moved relative to the first item 14. In one aspect, the second item 18 can be moved about and between a first position, in which the magnetic force between the first magnet 12 and the second magnet 16 is not strong enough to couple the second item 18 to the first item 14, and a second position, in which the magnetic force between the first magnet 12 and the second magnet 16 is strong enough to couple the second item 18 to the first item 14.

For example, if the first item 14 is the bottle 20, and the second item 18 is the lid 22, the lid 22 can be in a closed, first position (shown in FIGS. 1 and 2) in which the lid 22 seals the interior bottle chamber 26 to prevent liquids from leaving the chamber 26. As illustrated in FIG. 3, the lid 22 can be relocated to an open, second position in which the interior bottle chamber 26 is not sealed. The first magnet 12 and the second magnet 16 can cooperate to securedly, releasably hold the lid in the open, second position.

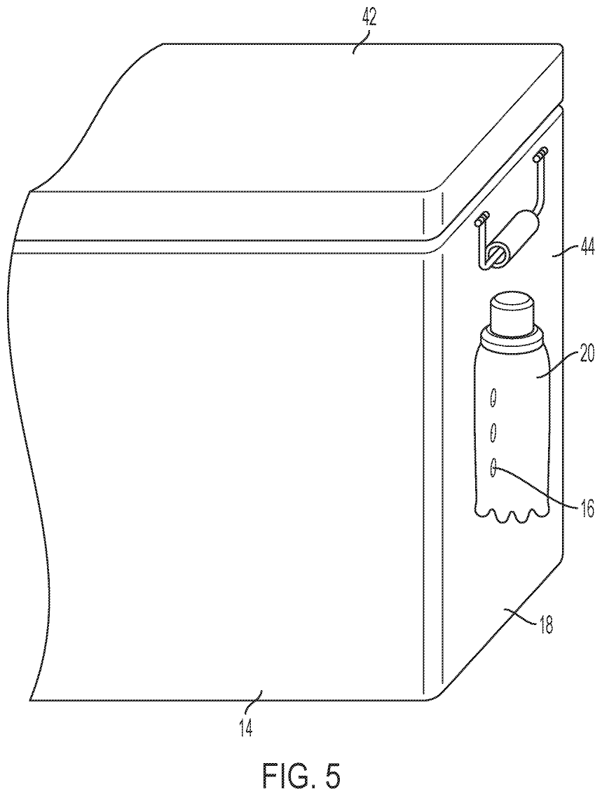

Although reference is made herein to the first item 14 being a bottle 20 and the second item 18 being a cap or lid 22 of the bottle 20, it is contemplated that the first item 14 and the second item 18 can be other items. In one aspect, and as illustrated in FIGS. 4 and 5, the first item 14 can be a cooler 42 and the second item 18 can be the bottle 20. In this aspect, the cooler 42 can comprise an interior cooler wall (not shown) and an outer cooler wall 44 spaced from the interior cooler wall a predetermined distance to define the first cavity 24. The first magnet 12 can be positioned and/or embedded in the first cavity 24 of the cooler 42. The bottle 20 comprising at least one second magnet 16 can be securedly, releasably attached to the cooler 42 by aligning at least a portion of the second magnet 16 with the first magnet 12.

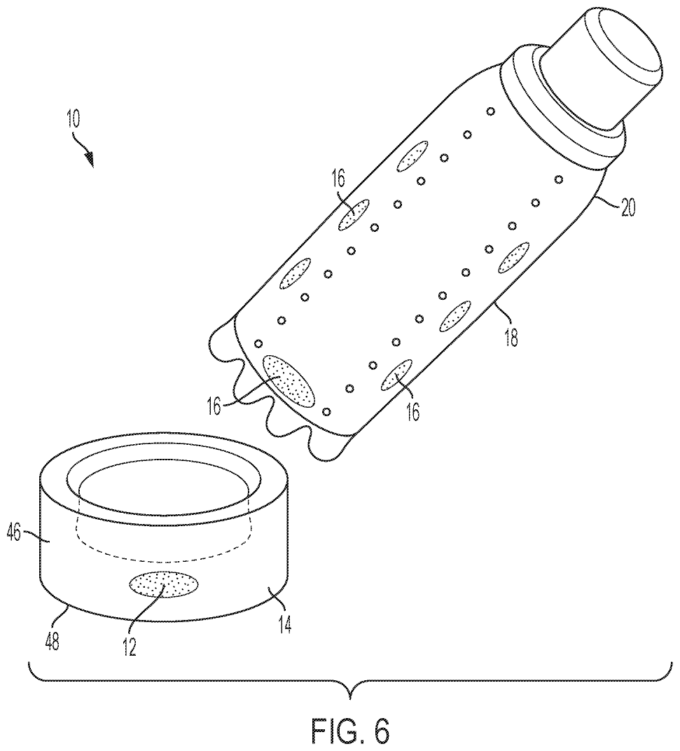

Referring now to FIG. 6, in another aspect, the first item 14 can be a cup holder 46 or bottler holder, and the second item 18 can be the bottle 20. In this aspect, the first magnet 12 can be positioned and/or embedded in a wall 48 of the cup holder 46. The bottle 20 comprising at least one second magnet 16 can be securedly, releasably attached to the cup holder 46 by aligning at least a portion of the second magnet 16 with the first magnet 12. For example, the cup holder 46 can be formed integrally with a car such that the bottle 20 can be securedly held in place as the car is moving. Optionally, the cup holder 46 can be an insert configured to fit into a cup holder formed integrally with a car. In this aspect, the cup holder 46 can be positioned in any car having an integrated cup holder to securedly, releasably hold the bottle 20.

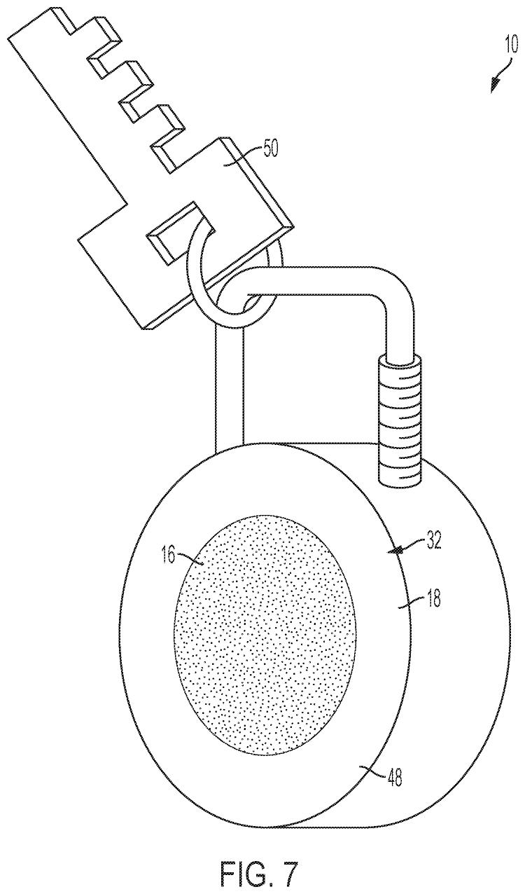

In another aspect and with reference to FIG. 7, the second item 18 can be a key fob 48. In this aspect, the second magnet 16 can be positioned in a second cavity 32 defined in the key fob 48. In this aspect, the first item 14 can be the bottle 20, the cooler 42, the cup holder 46 or any other device in which it would be convenient to attach a key 50.

In another aspect, the tethering system 10 does not comprise magnets and instead comprises other mechanical tethering systems. The tethering systems 10 (whether magnetic or non-magnetic) can be used to attach pieces of products or complementary components in certain beneficial locations, manners and the like. The tethering systems 10 can also help maintain a desired orientation of the product or device. The tethering systems 10 can also assist in the access and/or retrieval of a device, piece, component and the like. Further, the tethering systems 10 can comprise sensors such as, for example and without limitation, volume, condition, temperature, environmental and location. Further, the tethering systems 10 can have alternative and complimentary functionality such as lighting (metric, location, ornamental and the like), physical and/or remotely accessible and/or controllable, etc. Further, the tethering systems 10 can be integrated on, in, around, over, surface-mounted, mounted in channels, or in proximity to the products desired to be managed and/or augmented. Further tethering systems 10 can be integrated in continuous, segmented, fixed and/or adjustable layouts.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

What is claimed is:

1. A tethering system comprising:
a bottle defining an interior bottle chamber for holding a liquid, the bottle comprising an interior bottle wall and an outer bottle wall spaced from the interior bottle wall a predetermined distance to define a first cavity;
a removable lid for sealing the interior bottle chamber;
at least one first magnet coupled to and positioned in the first cavity of the bottle such that the first magnet is out of sight of a user of the system; and
at least one second magnet coupled to the lid,
wherein the lid is movable about and between a closed position, in which the interior bottle chamber is sealed by the lid, to an open position, in which the interior bottle chamber is not sealed by the lid and in which only a magnetic force between the first magnet and the second magnet securedly, releasably holds the lid in the open position.

2. The tethering system of claim 1, wherein the at least one first magnet comprises a plurality of first magnets positioned in the first cavity of the bottle.

3. The tethering system of claim 2, wherein the plurality of first magnets are spaced around the first cavity of the bottle a predetermined distance.

4. The tethering system of claim 2, wherein the plurality of first magnets are grouped in a desired area of the first cavity.

5. The tethering system of claim 1, wherein in the open position, the lid is coupled to the outer bottle wall.

6. The tethering system of claim 1, wherein the bottle further comprises a cover, and wherein the first magnet and the second magnet are sized and shaped so that the first magnet attracts the second magnet through the cover.

7. A method of tethering a first item to a second item, the method comprising:
providing a bottle defining an interior bottle chamber for holding a liquid, the bottle comprising an interior bottle wall and an outer bottle wall spaced from the interior bottle wall a predetermined distance to define a first cavity;
providing a removable lid for sealing the interior bottle chamber;
coupling at least one first magnet in the first cavity of the bottle such that the first magnet is out of sight of a user of the system;
coupling at least one second magnet to the lid;
positioning the lid in a closed position in which the interior bottle chamber of the bottle is sealed by the lid; and
moving the lid from the closed position to an open position, in which the interior bottle chamber is not sealed by the lid and in which only a magnetic force between the first magnet and the second magnet securedly, releasably holds the lid in the open position.

8. The tethering method of claim 7, wherein the at least one first magnet comprises a plurality of first magnets positioned in the first cavity of the bottle.

9. The tethering method of claim 8, wherein the plurality of first magnets are spaced around the first cavity of the bottle a predetermined distance.

10. The tethering method of claim 8, wherein the plurality of first magnets are grouped in a desired area of the first cavity.

11. The tethering method of claim 7, wherein in the open position, the lid is coupled to the outer bottle wall.

12. The tethering method of claim 7, wherein the bottle further comprises a cover, and wherein the first magnet and the second magnet are sized and shaped so that the first magnet attracts the second magnet through the cover.

13. A tethering system comprising:
a cooler defining an interior cooler chamber, the cooler comprising an interior cooler wall and an outer cooler wall spaced from the interior cooler wall a predetermined distance to define a first cavity;
a bottle for holding a liquid;
at least one first magnet coupled to and positioned in the first cavity of the cooler such that the first magnet is out of sight of a user of the system; and
at least one second magnet coupled to the bottle,
wherein the bottle is movable about and between a first position, in which the magnetic force between the first magnet and the second magnet is not strong enough to couple the bottle to the cooler, and a second position, in which the magnetic force between the first magnet and the second magnet is strong enough to securedly, releasably couple the bottle to the cooler.

14. The tethering system of claim 13, wherein the at least one first magnet comprises a plurality of first magnets positioned in the first cavity of the cooler.

15. The tethering system of claim 14, wherein the plurality of first magnets are spaced around the first cavity of the cooler a predetermined distance.

16. The tethering system of claim 14, wherein the plurality of first magnets are grouped in a desired area of the first cavity.

17. The tethering system of claim 13, wherein the bottle defines an interior bottle chamber for holding a liquid, the bottle comprising an interior bottle wall and an outer bottle wall spaced from the interior bottle wall a predetermined distance to define a second cavity; and wherein the at least one second magnet is positioned in the second cavity of the bottle such that the second magnet is out of sight of a user of the system

18. The tethering system of claim 17, wherein in the second position, the bottle is coupled to an outer wall of the cooler.
